(19) United States
(12) Patent Application Publication
(10) Pub. No.: US 2013/0058212 A1
(43) Pub. Date: Mar. 7, 2013

(54) OPTIMIZATION OF THE TRANSMISSION CONTROL PROTOCOL PARTICULARLY FOR WIRELESS CONNECTIONS

(71) Applicants: Ariel Noy, Herzlia (IL); Gideon Kaempfer, RaAnana (IL); Oded Shimon, Tel-Aviv (IL); Ron Sidi, Bat-Yam (IL); Sharon Barkai, Los Altos, CA (US)

(72) Inventors: Ariel Noy, Herzlia (IL); Gideon Kaempfer, RaAnana (IL); Oded Shimon, Tel-Aviv (IL); Ron Sidi, Bat-Yam (IL); Sharon Barkai, Los Altos, CA (US)

(73) Assignee: ConteXtream Ltd., Petach-Tikva (IL)

(21) Appl. No.: 13/604,844

(22) Filed: Sep. 6, 2012

Related U.S. Application Data
(60) Provisional application No. 61/531,646, filed on Sep. 7, 2011.

(51) Int. Cl. H04W 28/02; H04W 24/04

(52) U.S. Cl. 370/230

(57) ABSTRACT

TCP Proxy apparatus for a wireless network section to a TCP-enabled network includes a latency aware unit for monitoring round trip time over the wireless access network section to determine latency within the access section; and a filter for filtering out momentary changes in the latency. Momentary fluctuations in the wireless connection causes instantaneous packet loss, which merely requires minimal packet retransmission, temporarily affecting latency. The filter ensures that such fluctuations do not activate the TCP congestion avoidance mechanisms and unnecessarily slow down the overall transmission rate.

### RELATED APPLICATION

This application claims the benefit of priority under 35 USC §119(e) of U.S. Provisional Patent Application No. 61/531,646 filed Sep. 7, 2011, the contents of which are incorporated herein by reference in their entirety.

### FIELD AND BACKGROUND OF THE INVENTION

The present invention, in some embodiments thereof, relates to optimization of the Transmission Control Protocol or TCP, and particularly to its optimization for use over connections that include wireless links.

TCP is the complement of the Internet Protocol IP, which together form TCP/IP the original component of the Internet. TCP provides reliable, ordered delivery of a stream of bytes from one computer, or a program on that computer, to another program on another computer.

With the proliferation in use of wireless devices in recent years, there has been a growing interest in access to mobile Internet and web-based applications. TCP, being a popular transport layer protocol for the Internet, is primarily responsible for transfer of Internet data in heterogeneous networks comprised of wired and wireless links. However, TCP was originally designed to operate in wire-line environments where the channel conditions are highly reliable and data losses are primarily due to congestion. It thus faces operational challenges in wireless scenarios that are characterized by short term changes in channel conditions, causing symptoms such as sporadic losses, packet delays due to wireless link layer retransmissions and even disconnections.

TCP, having been designed for the wire environment, perceives the losses on a wireless link to be an indication of network congestion and automatically invokes congestion control mechanisms. Congestion control assumes the problem is long term and as such primarily entails a reduction in data transfer rate and impairment of the end-to-end throughput. Such a solution is generally the wrong solution when the problem is short term changes in channel conditions in a wireless environment and leads to the link capacity being underused most of the time.

Solutions that have been proposed in recent years to counter the problem include end-to-end schemes, split connection approaches, and TCP aware link layer protocols.

The end-to-end schemes as suggested, for example, in Balakrishnan et al., “A Comparison of Mechanisms for Improving TCP Performance over Wireless Links,” IEEE/ACM Transactions on Networking, 1998, and Gupta et. al., “Reliable ELN to enhance throughput of TCP over wireless links via TCP header checksum,” IEEE Global Telecommunications Conference, vol. 2, p. 1985-1989, 2002, involve making changes to TCP to make it capable of distinguishing between congestion and wireless link losses. The Explicit Loss Notification (ELN) is one such end-to-end mechanism. The ELN option is added to TCP acknowledgements. When a segment is dropped on a wireless link, the acknowledgements for the subsequent segments are marked to identify that a non-congestion loss has occurred. On receiving such an acknowledgement, the TCP source can perform retransmission of the lost segment without invoking congestion control mechanisms. Although end-to-end schemes preserve TCP semantics, these require modifications to TCP. The infeasibility of Internet wide deployment of such changes poses a severe restriction to the practical utility of such solutions.

The split-connection approaches, as suggested, for example, in Bakre et al., “Handoff and System Support for Indirect TCP/IP,” 2.sup.nd USENIX Symposium on Mobile and Location-dependent Computing, p. 11-24, 1995, and Brown et. al., “M-TCP: TCP for Mobile Cellular Networks,” ACM SIGCOMM Computer Communications Review, 1997, divide the TCP connection between the source and destination into two distinct connections—one between the source and the base station (BS) and the other between the BS and the destination. A specialized protocol tuned to the wireless environment can be used for the connection that extends over the wireless hop. The split-connection approach is, however, marred by increased processing overheads, violation of end-to-end semantics of TCP acknowledgements, and slow, complicated handoffs.

Enhanced link layer reliability as suggested, for example, in Miyoshi et al., “Performance Evaluation of TCP Throughput on Wireless Cellular Networks,” IEEE Vehicular Technology Conference, 2001, has been investigated as a mechanism to improve TCP performance in wireless scenarios. However, link layer designs that are TCP unaware cannot efficiently shield TCP from the wireless losses, and are also associated with increased rate and delay variability as described in Chan et. al., “TCP/IP Performance over 3G Wireless Links with Rate and Delay Variation,” ACM MobiCom, p. 71-82, 2002. On the other hand, approaches along the lines of the SNOOP protocol suggested in Balakrishnan et al., “Improving TCP/IP Performance over Wireless Links,” ACM MobiCom, 1995, represent a TCP aware link layer design. While SNOOP preserves the end-to-end semantics of TCP and does not require any changes to TCP implementation, it has its own share of limitations. It cannot be used for the case when TCP data and ACKs do not both traverse through the base station BS or an access point (AP). The protocol also has overhead associated with SNOOP cache maintenance. Moreover, during the interim period between the handoffs, the Base Station (BS) or Access Point (AP) to which the handoff occurs cannot snoop on any acknowledgements sent from the mobile host. Another disadvantage of the SNOOP protocol is its inability to function when TCP headers are encrypted.

Mobile IP provides an efficient, scalable mechanism for roaming within the Internet. Using Mobile IP, nodes may change their point-of-attachment to the Internet without changing their home IP address. This allows them to maintain transport and higher-layer connections while roaming. Node mobility is realized without the need to propagate host-specific routes throughout the Internet routing fabric.

The Mobile IP protocol allows location-independent routing of IP datagrams, or packets, on the Internet. Each mobile node is identified by its home address disregarding its current location in the Internet. While away from its home network, a mobile node is associated with a care-of address which identifies its current location and its home address is associated with the local endpoint of a tunnel to its home agent. Mobile IP specifies how a mobile node registers with its Home Agent (HA) and how the HA routes datagrams to the mobile node through the tunnel. In 4G/LTE wireless networks the HA function is performed by a Packet Data Network Gateway (PGW).

TCP tightly controls the amount of outstanding unacknowledged data that is sent into the network by a mechanism known in the art as a congestion window. The congestion window determines the most advanced sequence number of data that may be sent into the network at any given time. Upon the receipt of an acknowledgement, the congestion window may be advanced and hence more data may be sent into the network. By controlling the size of the congestion window, the rate of transmission is indirectly controlled as well since for a given Round Trip Time (RTT) the transmission rate can typically be expressed by the congestion window divided by the RTT. The congestion window expresses what is known in the art as the “bandwidth delay product”. The method by which the size of the congestion window, and hence the transmission rate, is adjusted is part of what is known in the art as the congestion avoidance algorithm.

TCP implementations may be divided into two main classes based on their congestion avoidance algorithms: Loss aware algorithms and latency aware algorithms. Most TCP implementations used on the Internet such as TCP Reno or TCP CUBIC are loss aware algorithms. These algorithms regard packet loss as an indicator of congestion leading to reduction in the size of the congestion window, and hence in transmission rate. Some TCP implementations such as TCP Vegas or Fast TCP (“FAST TCP: motivation, architecture, algorithms, performance”, Cheng Jin, David X. Wei and Steven H. Low. IEEE Infocom, March 2004) use the latency between TCP endpoints as an indication for congestion. Upon the increase of end to end latency the congestion window is reduced while a reduction in latency may lead to growth of the congestion window.

While loss aware algorithms work well in environments where loss is the result of queue overflow due to congestion they fail to allow high data rate transfers in environments with significant packet loss such as wireless networks. Pure latency aware algorithms are not sensitive to packet loss, and may hence operate more consistently over networks with significant loss. However, they may be extremely sensitive to latency buildup that is the result of link layer retransmission queues which does not represent congestion.

Finally, as wireless data networks become faster and faster, the issue of recovery from packet loss becomes more severe since the higher the rate, the longer it takes a typical TCP server to reach peak rate after packet loss. This becomes very severe in 4G/LTE networks to the extent that the peak rate is rarely reached due to the frequency of packet loss.

### SUMMARY OF THE INVENTION

The present embodiments provide a modification to the TCP algorithms to ensure that momentary rate changes on the wireless network do not affect the overall TCP throughput.

More particularly, a TCP Proxy apparatus for a wireless network section to a TCP-enabled network includes a latency aware unit for monitoring round trip time over the wireless access network section to determine latency within the access section; and a filter for filtering out momentary changes in the latency. Momentary fluctuations in the wireless connection causes instantaneous packet loss, which merely requires minimal packet retransmission, temporarily affecting latency. The filter ensures that such fluctuations do not activate the TCP congestion avoidance mechanisms and unnecessarily slow down the overall transmission rate.

According to an aspect of some embodiments of the present invention there is provided a TCP Proxy apparatus for a wireless network section comprising:

a latency aware unit for monitoring round trip time over the wireless network section to determine latency within the wireless section; and

a filter for filtering out momentary increases in the latency that exceed a threshold significance level, the filtered latency being used to generate a TCP congestion avoidance window.

The apparatus may be configured for location at an entry point from a core network to the wireless network section, and wherein the wireless network section comprises a wireless access network for wireless devices to the core network.

In an embodiment, the filter is configured to identify a minimum measured round trip time over a period of time and to ignore round trip times received within the period that exceed the threshold level of significance unless a predetermined period of time has been exceeded.

In an embodiment, the predetermined period of time being one member of the group consisting of: less than five seconds, less than four seconds, less than three, seconds, less than two seconds, less than one second, and less than half a second.

In an embodiment, the filter is configured to output a value being a lowest of a plurality of latency measurements over a preset time frame.

An embodiment may be configured with a congestion unit to calculate congestion over the network connection and to set a congestion window of data for sending, the congestion unit connected to use output of the filter as an indication of the latency, thereby preventing short term changes due to channel conditions from affecting the congestion window.

In an embodiment, the congestion unit is configured to calculate a congestion window W as a function of the filter output, and further to use the congestion window W with the filter output in order to calculate a transmission rate R and to limit the maximum sequence number of packets to be transmitted.

In an embodiment, the congestion unit is associated with a transmission unit configured to consider a TCP receiver window and to limit transmission to a transmission window size under a predefined condition.

In an embodiment, the transmission unit is configured to apply transmission shaping to the packets, by allowing transmission above a predetermined assured rate only if a sequence number of a packet to be transmitted lies within the transmission window.

In an embodiment, the shaper is configured with a burst size, B, a maximum transmission rate, and an assured transmission rate being a percentage, H %, of the maximum transmission rate, and wherein the maximum transmission rate is a function of the congestion window size and the filtered latency.

In an embodiment, H lies between 40% and 80%.

In an embodiment, the predefined condition comprises transmitting a packet if and only if:

a last sequence number of the packet is within a receive window; and

either the last sequence number is within a congestion window; or

the packet is transmittable within an assured rate controlled by the shaper.

In an embodiment, the apparatus may provide a communication split point for TCP communications traversing the network from a first end in the wireless network section to a second end, the split point terminating TCP connections from both of the ends, the apparatus managing the wireless network section using the filter.

According to a second aspect of the present invention there is provided a wireless network access section for providing access to a general network comprising:

a TCP proxy for managing TCP communication therein, the proxy comprising:
a latency aware unit for monitoring round trip time over the wireless access network section to determine latency within the wireless access section; and
to a filter for filtering out momentary increases in the latency that exceed a predetermined significance threshold, the filtered latency being used to generate a TCP congestion avoidance window.

According to a third aspect of the present invention there is provided a TCP-based communication network having a plurality of access network sections for providing access thereto, at least some of the access networks being wireless access networks;

at least some of the wireless access networks having a TCP proxy for managing TCP communication therein, respective proxies comprising:
a latency aware unit for monitoring round trip time over the wireless access network section to determine latency within the wireless access section; and
a filter for filtering out momentary increases in the latency that exceed a predetermined significance threshold, the filtered latency being used to generate a TCP congestion avoidance window.

According to a fourth aspect of the present invention there is provided a TCP Proxy method for a wireless network section comprising:

monitoring round trip time over the wireless access network section to determine latency within the wireless access section;

filtering out momentary increases in the latency that exceed a predetermined significance threshold; and

using the filtered latency to generate a TCP congestion avoidance window.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of to embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. The data processor may include a volatile memory for storing instructions and/or data and/or a non-volatile storage, for example, a magnetic hard-disk, flash memory and/or removable media, for storing instructions and/or data. A network connection may be provided and a display and/or a user input device such as a keyboard or mouse may be available as necessary.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a generalized figure of an overall network with separate access networks including a wireless access network, to which the present embodiments may be applied;

FIG. 2 is a simplified block diagram illustrating an embodiment of the present invention applied to the network arrangement of FIG. 1;

FIG. 3 is a simplified block diagram showing in greater detail the TCP proxy of FIG. 2;

FIG. 4 is a generalized flow chart showing operation of a modified TCP procedure for wireless network sections according to an embodiment of the present invention;

FIG. 5 is a simplified diagram showing the setting of a congestion window and an actual transmission rate according to the present embodiments; and

FIG. 6 is a simplified diagram showing a procedure for transmitting a data packet using a sequence of conditions according to an embodiment of the present invention.

### DESCRIPTION OF SPECIFIC EMBODIMENTS OF THE INVENTION

The present invention, in some embodiments thereof, relates to a modification of the TCP protocol, in particular for wireless access network sections.

The modification may comprise using a filter or equivalent means to provide the practical effect of filtering out instantaneous changes in latency due to momentary fluctuations in the wireless section of a network. Momentary fluctuations in the wireless connection causes instantaneous packet loss, which merely requires minimal packet retransmission, temporarily affecting latency. The filter ensures that such fluctuations do not activate the TCP congestion avoidance mechanisms and unnecessarily slow down the overall transmission rate. This relates in particular to TCP implementations which are purely latency aware or which include latency and loss as input into their congestion avoidance mechanisms. It is noted that there are congestion avoidance algorithms which react to packet loss, but use the minimal RTT to calculate the congestion window upon such Packet loss events. One such example is TCP Westwood.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

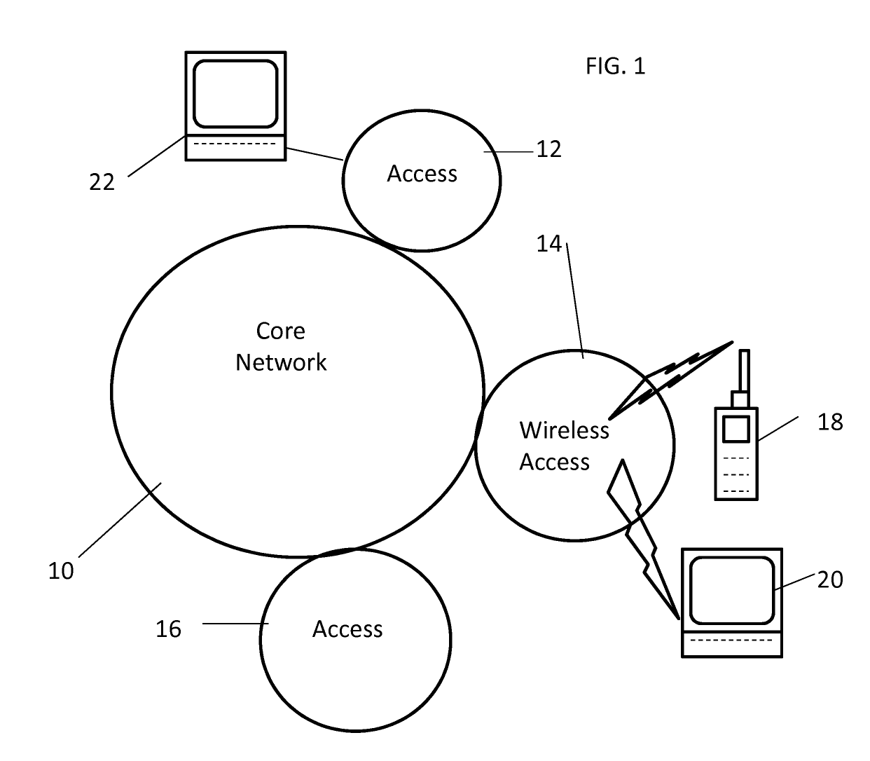

Referring now to the drawings, FIG. 1 illustrates a general, or core, network 10 that uses TCP as its communication protocol. Access networks 12, 14 and 16 provide local access connections to users. Access network 14 is a wireless access network to which wireless end users 18 and 20 are connected. Wired user 22 connects via wired access network 12 to communicate with the wireless users.

Typically access network 14 is a 3G cellular telephony network or a 4G, or LTE, cellular telephony network. Alternatively, wireless access network 14 is a wireless Lan or the like. More generally the embodiments apply to any network which suffers loss from link conditions rather than congestion, including satellite networks and even wireline networks under certain conditions. For example, in the future, a wired technology may be used which would allow very high bandwidth at the cost of bursty loss.

As discussed in the background, the wireless access network behaves differently from a wired access network in that the wireless network shows very short term effects on network availability which generally do not occur in wired networks. TCP was designed for wired networks and without modification, tends to react to the short term changes as if they were long term changes, thus unnecessarily slowing down communication to deal with what it perceives as network congestion.

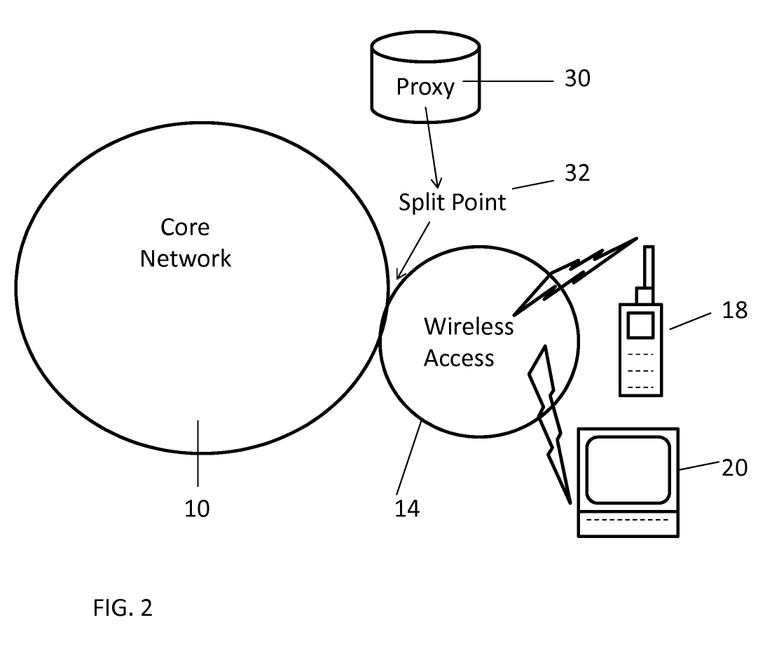

Reference is now made to FIG. 2 which illustrates a TCP Proxy 30 according to the present embodiments, applied to at a split point 32 between the core network 10 and the wireless access network 14. The TCP proxy terminates the TCP connection over the general network at split point 32 and sets up a separate TCP connection over the wireless access section 14.

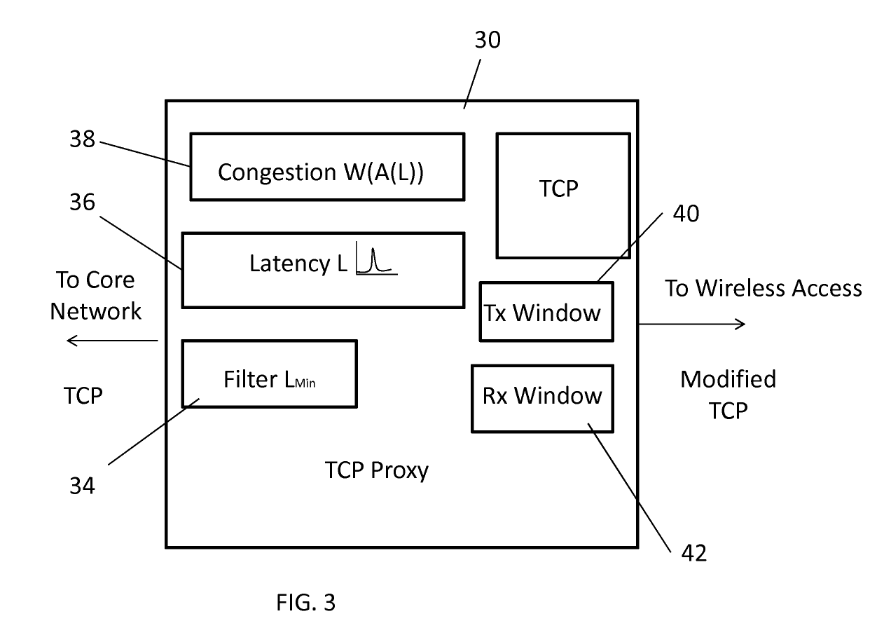

Reference is now made to FIG. 3, which is a simplified diagram showing in greater detail the TCP proxy server 30 of FIG. 2. The TCP proxy server acts as a TCP terminating connection to both sides of a TCP connection, using a modified TCP protocol for the wireless side of the connection.

In the wireless side of the connection, a filter 34 is used to filter out short term fluctuations in the latency. The latency itself is measured by a latency unit 36 through monitoring of round trip times over the network. It is noted that RTT measurement is not based on a specific packet since no packet is actually sent back and forth. The normal estimate is based on the latency between sending a packet and receiving an acknowledgement on it. Another way is to use the standard TCP timestamps option if implemented, or any other method which obtains a time which is consistent with actual latency over the network.

Filter 34 may be implemented as a low pass filter. Alternatively Filter 34 could define a monitoring window length and consistently report round trip times. A minimum round trip time since the previous time of report is measured. If this minimum round trip time exceeds the previously reported round trip time by a significant margin, the previous report is repeated unless the time since the last time the recently measured minimum round trip time has exceeded a time T. If the minimum round trip time measured does not exceed the previously reported round trip time by a significant margin or if time T has been exceeded, the measured minimum round trip time is reported. Time T may for example be any of: less than five seconds, less than four seconds, less than three seconds, less than two seconds, less than one second, or less than half a second, or any other suitable time frame found experimentally to exclude short term changes in the particular network being considered.

An algorithm, hereinafter referred to as A( ), which is a function of the latency, is available. Instead of feeding the algorithm with the current calculated or measured latency, the algorithm is fed with the filtered latency reports.

The algorithm produces a result which is a window size Wₑₘᵤ.

From this point on, two possibilities are available.

One possibility is to use the window as the normal TCP congestion window cwnd to control which packets may be transmitted. That is to say the window defines a maximum distance between the sequence number of the last contiguously acknowledged sequence number and the most advanced sequence number that may be sent to the receiver.

A second possibility is to use the window in order to define a transmission rate and perform transmission using a shaper mechanism while possibly partially disregarding the sequence number limitation imposed by the window. This is done by first calculating a rate R_act from the window and minimum latency observed W_emu/Lmin and then transmitting at the maximum rate R_act as long as one remains within the window or at a lower “assured rate” H %*R_act. In both cases, the transmission is governed by a shaper which limits the maximum burst size.

Thus, at least in the first of the two possibilities above, the congestion unit 38 calculates congestion over the wireless network connection and sets a transmit congestion window 40 of data for sending. The congestion unit is latency aware through use of the filter output as an indication of latency, and differs from standard latency aware algorithms in use of the filtered rather than the pure latency measurements, as will be explained in greater detail below.

The congestion unit 38 calculates congestion window Cwnd, which can be converted into terms of packet rate. Normally, cwnd is sufficient for TCP to govern transmission, indirectly affecting rate by merely defining the range of sequence numbers of packets that may be sent into the network as known in the art. Then, in a further step, The calculated Cwnd is then used to calculate a further rate as a function of the filter output—here denoted as Lₘᵢₙ. Lmin is the filtered round trip time RTT as will be described in greater detail below. The congestion unit uses the congestion window W together with the filter output together with transmission shaping, for transmitting packets over the wireless section.

A transmission window is then calculated as a minimum of the congestion window and a TCP receiver window 42 received from the destination, in order to limit transmission under certain conditions such as when the receiver has only limited ability to absorb traffic.

In the second possibility, the TCP transmission may use a dual token bucket shaper. Typical configuration settings for the shaper are a burst size of B, an assured rate of transmission R_act*H % where the maximum rate of transmission is R_act. Values for these settings may be as follows: B is expressed in bytes and is normally derived by multiplying R act with a value which may lie within 1 and 20 msec with a typical value of 10 ms. H may lie between 40% and 80% with a typical value of 60%.

A typical condition for sending packets may be as follows:

transmit a packet if and only if:

a last sequence number of the packet is within a receive window; and

either the last sequence number is within a congestion window, hereinbelow Wemu; or

the packet can be transmitted within the assured rate defined above as controlled by the shaper.

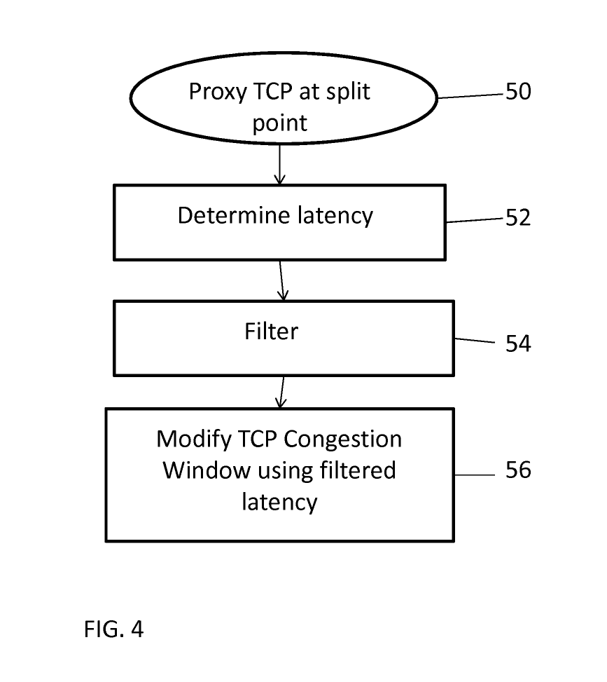

Reference is now made to FIG. 4, which is a simplified flow chart illustrating operation of a TCP proxy modifying the TCP protocol over a wireless section of network. The proxy TCP is set up to split a TCP communication at a split point between the core and wireless network access sections—box 50.

In box 52 monitoring is carried out of round trip time over the wireless access network section to determine the latency in the section. In box 54 filtering is carried out to filter out momentary changes in the latency, so that the momentary changes do not influence the algorithm for setting the TCP congestion window in box 56. More particularly, if momentary changes are within bounds of certain limited changes, they are actually accepted, as discussed further below.

The present embodiments are now considered in greater detail.

First of all it is noted that the present embodiments may be classified under the split-connection approach as defined above and thus requires a split point at which the modified algorithm takes over. A mobile entity not only does not have a fixed location but furthermore can move from one location to another during the course of a connection. In order to avoid handoff issues, the split point (32 in FIG. 2) may be positioned at or near the Home Agent (HA) or PDN Gateway (PGW) which is a fixed entity regardless of the actual location of a mobile end point 18, typically located on a cellular network.

The split point acts as a TCP proxy terminating the TCP connection from both ends. Over the hop towards the mobile end point, a generic method is provided for transforming any latency aware TCP congestion avoidance algorithm into an algorithm that is capable of coping with the special effects created by the wireless link, namely the short term effects of severely increased latency.

A method for transmission over a hop including a wireless link is based on any given latency aware TCP congestion avoidance algorithm A(L) where L is a round-trip latency measurement or calculation. Several such algorithms are designed for TCP and are known to the skilled person.

The algorithm A(L) is used in order to calculate a congestion window W(A(L)) where L is derived from measured Round Trip Time (RTT) indications. L is derived such that temporary extreme fluctuations in latency are ignored, such as fluctuations due to wireless retransmissions, but slow changes in the RTT are tracked accurately. In a sense this is a low pass filter on the RTT measurements.

The calculated congestion window W(A(L)) and the corresponding L are used in order to calculate a transmission rate R and to limit the maximum sequence number of packets to be transmitted. Here, two cases may be distinguished. The first case is the simple case where the window is used as the cwnd in the normal TCP transmission algorithm (i.e. simply for governing the maximum sequence number that may be sent towards the destination).

The second case is one in which the window is used in order to derive a transmission rate which is then governed by a shaper and the congestion window.

Finally, transmission also takes the TCP receiver window into account limiting transmission if required.

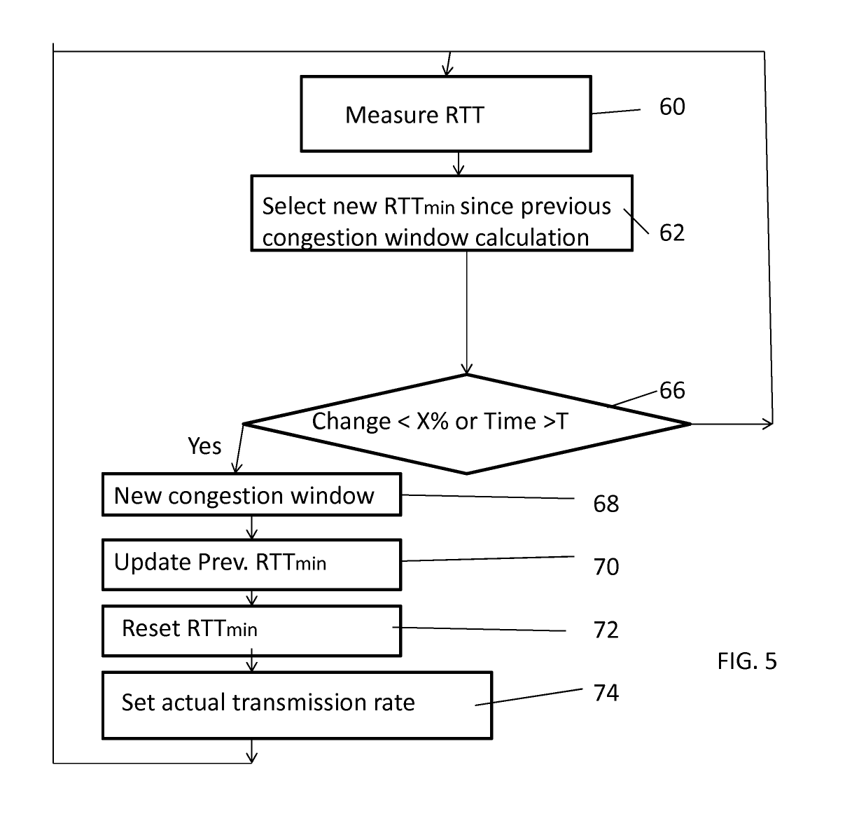

The method for transmission rate determination in the modified TCP protocol is now given in greater detail, with reference to FIG. 5, which is a simplified flow chart illustrating the method.

Let A(L) be a latency L aware congestion avoidance algorithm which defines a method for calculating a next congestion window W(A(L)). As mentioned, several such algorithms are used in versions of the TCP protocol.

Let prev_RTT_min be the last latency L used for calculating W(A(L)). Let T be a probing timeframe, for example: 2 seconds.

In box 60 the method measures RTT. As mentioned above, measurement is normally not direct. There are numerous ways for deriving RTT, such as using the TCP timestamp or measuring time between transmission of a packet and acknowledgement thereof, and furthermore there are various well known methods for filtering the results in order to derive the RTT (before applying the present low pass filter). The normal goal of the above measurement is to generate a good estimate of the real RTT. After receiving these good estimates, the low pass filter ignores some of them in an attempt to remove the effect of temporary RTT fluctuations over a longer timescale than TCP would normally remove. In particular, significant increases in latency of a duration less than the probing timeframe T are ignored. However, if latency increases somewhat for short periods of time between window calculations, such increases may be taken into account as detailed below.

The measurement may be invoked every time a packet arrives or once every fixed or variable number of packets. The measurement may be based on timestamps inserted into packets as defined in IETF RFC1323 or any other method.

Box 62 determines the minimal RTT observed, RTTₘᵢₙ, since the last time a congestion window W_emu was calculated. Thus, if a time corresponding to RTTₘᵢₙ has elapsed or after every fixed time as defined by A(L) or otherwise defined for recalculating a new congestion window, then box 62 checks for a recently calculated RTTₘᵢₙ.

Decision box 66 sets the time condition above. If RTTₘᵢₙ is less than X % of the prev_RTTₘᵢₙ (X % is typically between 110% and 200%, such as 110%, 120%, 150%, 180% or 200%) or if T time has elapsed since the last W_emu calculation then program flow goes to box 68. In other words, box 66 provides the condition for updating the congestion window. In one case, RTTmin is no higher than (X−100) percent above the previous RTTmin. That is to say it is lower or at most a little bit higher, in which case the normal window update interval as defined by A( ) is tracked. Alternatively, time T has passed since the last update, and during that time the RTTmin has consistently been much higher than the previous RTTmin.

In box 68 the method calculates the next emulated congestion window as W_emu :=W(A(RTTₘᵢₙ)) immediately.

In box 70 the prev_RTTₘᵢₙ is set as RTTₘᵢₙ. That is to say the RTT now used for the window update is stored as prev_RTTmin.

In box 72 RTT_min is set to a maximum integer (reset RTTₘᵢₙ). In other words, one forgets about the old RTTmin and begins looking for a new minimum from the time the window is updated. By setting RTTmin to max integer, one implies that the next time a measurement of RTT takes place the measurement will become the new RTTmin. Hence every time a new measurement takes place and RTT is smaller than RTTmin, RTTmin is updated accordingly to be that new minimum.

W_emu may now be used by the standard TCP transmission algorithm as its calculated congestion window cwnd, in which case box 74 just implies the transmission rate is governed by the standard TCP transmission algorithm. Alternatively, the transmission algorithm is replaced by the following description of box 74.

In the alternative embodiment of box 74, the actual transmission rate R_act is set as W_emu/prev_RTT_min—the RTTmin for which this particular R_act was calculated. R_act is the actual rate of transmission as determined using A( ) to derive the window and dividing it by the appropriate latency measurement.

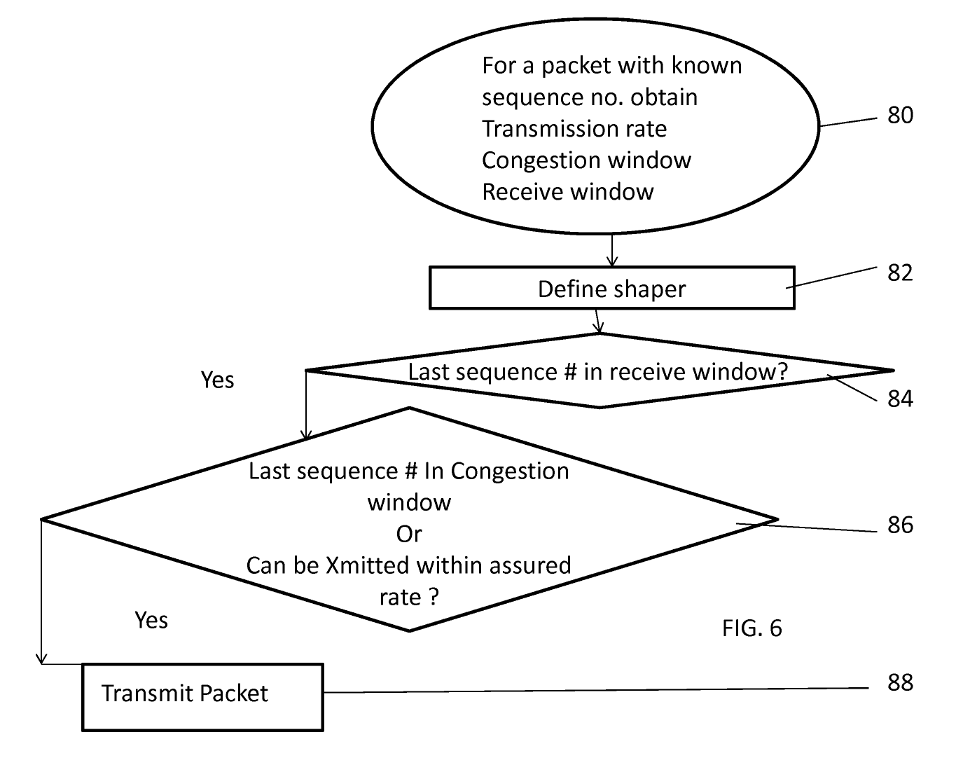

Reference is now made to FIG. 6, which is a simplified flow chart illustrating a further, optional, method for packet transmission according to embodiments of the present invention.

Let R_act be a transmission rate, W_emu a congestion window and W_rx a receiver window as typically defined in the art of TCP transmission. These values are obtained in box 80.

In box 82 a dual token bucket shaper as known in the art is defined with a burst size of B, assured rate of R_act*H % and max rate of R_act, where B may be 10 msec*R_act and H may be 60%. It is noted that the definition of the shaper does not change when R_act remains constant. It is only updated following an update of R_act.

Given a packet for transmission, the packet is transmitted in box 88 if and only if:

Its last sequence number is within the receive window W_rx, as per box 84 and as per box 86, its last sequence number is within the congestion window W_emu. As an option, the packet may also be transmitted within the assured rate defined above as controlled by the shaper. By “controlled by the shaper” it is meant that the shaper controls the burst size and allows transmission at a rate of up to the assured rate in any case and up to the maximum rate if the sequence numbers are within the W_emu window. Conventional shapers do not use sequence numbers as a criteria for transmission but instead use tokens and a token bucket. In conventional shapers tokens are added and deducted from the token bucket and a packet may only be transmitted when there are enough tokens in the bucket. In the shaper of the present embodiments tokens are used to govern the transmission as in a standard dual token bucket shaper, however, in addition, sequence numbers are also taken into account as a criterion for transmission. If no transmission takes place, no tokens are deducted from the token buckets. If a transmission takes place, tokens are deducted accordingly, and if there are no sufficient tokens to allow transmission, no transmission is allowed.

The procedures of FIGS. 5 and 6 ensure that packets are transmitted based on the congestion window calculated by the latency aware congestion avoidance algorithm as long as the latency decreases or increases by a fixed (low) percentage above the current minimal latency. In the event of a jump in latency above the fixed (low) percentage, as long as the minimal latency was measured within the sliding window of the past T seconds, transmission may commence even beyond the W_emu congestion window as long as it does not exceed the receive window W_rx and as long as the transmission rate does not exceed H% of the calculated rate R_act which is based on the congestion window calculated for the measurement of the minimal latency.

The present embodiments thus provide a TCP congestion avoidance algorithm for wireless networks based on a latency aware TCP congestions avoidance algorithm where a congestion window is calculated based on feeding the latency aware algorithm with the minimal latency measured over a timeframe. The wireless network may for example a cellular telephony network, including a 3G network, or a 4G or LTE network. In particular, 4G networks define high data rates.

The present embodiments may provide a TCP optimization system located between an HA or PGW and the Internet. As explained the system may serve as a TCP proxy implementing a TCP congestion avoidance algorithm for wireless networks based on a latency aware TCP congestion avoidance algorithm as explained, in which a congestion window is calculated based on feeding the latency aware algorithm with the minimal latency measured over a timeframe.

It is expected that during the life of a patent maturing from this application many relevant technologies will be developed and the scope of the corresponding terms in the present description are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. TCP Proxy apparatus for a wireless network section comprising:
a latency aware unit for monitoring round trip time over said wireless network section to determine latency within said wireless section; and
a filter for filtering out momentary increases in said latency that exceed a threshold significance level, said filtered latency being used to generate a TCP congestion avoidance window.

2. Apparatus according to claim 1, configured for location at an entry point from a core network to said wireless network section, and wherein said wireless network section comprises a wireless access network for wireless devices to said core network.

3. Apparatus according to claim 1, wherein said filter is configured to identify a minimum measured round trip time over a period of time and to ignore round trip times received within said period that exceed said threshold level of significance unless a predetermined period of time has been exceeded.

4. Apparatus according to claim 3, wherein the said predetermined period of time being one member of the group consisting of: less than five seconds, less than four seconds, less than three, seconds, less than two seconds, less than one second, and less than half a second.

5. Apparatus according to claim 1, wherein said filter is configured to output a value being a lowest of a plurality of latency measurements over a preset time frame.

6. Apparatus according to claim 1, further configured with a congestion unit to calculate congestion over said network connection and to set a congestion window of data for sending, said congestion unit connected to use output of said filter as an indication of said latency, thereby preventing short term changes due to channel conditions from affecting said congestion window.

7. Apparatus according to claim 6, wherein the congestion unit is configured to calculate a congestion window W as a function of said filter output, and further to use said congestion window W with said filter output in order to calculate a transmission rate R and to limit the maximum sequence number of packets to be transmitted.

8. Apparatus according to claim 7, wherein the congestion unit is associated with a transmission unit configured to consider a TCP receiver window and to limit transmission to a transmission window size under a predefined condition.

9. Apparatus according to claim 8, wherein said transmission unit is configured to apply transmission shaping to said packets, by allowing transmission above a predetermined assured rate only if a sequence number of a packet to be transmitted lies within said transmission window.

10. Apparatus according to claim 9, wherein said shaper is configured with a burst size, B, a maximum transmission rate, and an assured transmission rate being a percentage, H %, of said maximum transmission rate, and wherein said maximum transmission rate is a function of said congestion window size and said filtered latency.

11. Apparatus according to claim 10, wherein H lies between 40% and 80%.

12. Apparatus according to claim 9, wherein said predefined condition comprises transmitting a packet if and only if:
a last sequence number of said packet is within a receive window; and
either said last sequence number is within a congestion window; or
said packet is transmittable within an assured rate controlled by the shaper.

13. Apparatus according to claim 1, said apparatus providing a communication split point for TCP communications traversing said network from a first end in said wireless network section to a second end, said split point terminating TCP connections from both of said ends, said apparatus managing said wireless network section using said filter.

14. A wireless network access section for providing access to a general network comprising:
a TCP proxy for managing TCP communication therein, said proxy comprising:
a latency aware unit for monitoring round trip time over said wireless access network section to determine latency within said wireless access section; and
a filter for filtering out momentary increases in said latency that exceed a predetermined significance threshold, said filtered latency being used to generate a TCP congestion avoidance window.

15. A TCP-based communication network having a plurality of access network sections for providing access thereto, at least some of said access networks being wireless access networks;
at least some of said wireless access networks having a TCP proxy for managing TCP communication therein, respective proxies comprising:
a latency aware unit for monitoring round trip time over said wireless access network section to determine latency within said wireless access section; and
a filter for filtering out momentary increases in said latency that exceed a predetermined significance threshold, said filtered latency being used to generate a TCP congestion avoidance window.

16. TCP Proxy method for a wireless network section comprising:
monitoring round trip time over said wireless access network section to determine latency within said wireless access section;
filtering out momentary increases in said latency that exceed a predetermined significance threshold; and
using said filtered latency to generate a TCP congestion avoidance window.

17. Method according to claim 16, wherein said wireless network section comprises a wireless network access section for providing access to a core network for wireless devices.

18. Method according to claim 16, wherein said filtering comprises setting a lowest round trip time received over a predetermined period and ignoring, during said period, round trip times received which are larger than said predetermined significance threshold above said period.

19. Method according to claim 17, wherein said network access section comprises one member of the group consisting of a 3G cellular network, and a 4G cellular network.

20. Method according to claim 16, wherein said filtering comprises providing a value being a lowest of a plurality of latency measurements over a preset time frame.

21. Method according to claim 16, further comprising calculating congestion over said network connection and setting said TCP congestion avoidance window of data for sending, said calculating congestion using output of said filtering as an indication of said latency.

22. Method according to claim 21, further comprising calculating said TCP congestion avoidance window W as a function of said output of said filtering, and further using said filter output in order to calculate a transmission rate R and to limit the maximum sequence number of packets to be transmitted.

23. Method according to claim 22, further comprising considering a TCP receiver window and limiting transmission under a predefined condition.

24. Method according to claim 23, further comprising transmitting using a shaper, by allowing transmission above a predetermined assured rate only if a sequence number of a packet to be transmitted lies within said transmission window.

25. Method according to claim 24, wherein said shaper is configured with a burst size of B, a maximum transmission rate, and an assured rate of transmission being a predetermined percentage, H %, of said maximum transmission rate, and wherein said maximum transmission rate equals said congestion window size divided by said filtered latency.

26. Method according to claim 25, wherein H lies between 40% and 80%.

27. Method according to claim 25, wherein said predefined condition comprises transmitting a packet if and only if:
a last sequence number of said packet is within a receive window; and
either said last sequence number is within a congestion window; or
said packet is transmittable within said assured rate as controlled by the shaper.

28. Method according to claim 16, comprising providing a communication split point for TCP communications traversing said network from a first end in said wireless network section to a second end, said split point terminating TCP connections from both of said ends, and managing said wireless network section using said filtering.
